(19) United States
(12) Patent Application Publication
(10) Pub. No.: US 2012/0185776 A1
(43) Pub. Date: Jul. 19, 2012

(54) ANALYZING RESOURCE CONSUMPTION OF SOFTWARE EXECUTING DURING A USAGE SCENARIO

(75) Inventors: Alexander Kirshenbaum, Redmond, WA (US); Aaron E. Dietrich, Bothell, WA (US); Sharif Farag, Bothell, WA (US); Hemchand Alla, Issaquah, WA (US); Krishna Venkatesh, Seattle, WA (US); Kevin Michael Woley, Seattle, WA (US); Aaron Spinks, Kirkland, WA (US)

(73) Assignee: Microsoft Corporation, Redmond, WA (US)

(21) Appl. No.: 13/007,438

(22) Filed: Jan. 14, 2011

(51) Int. Cl. G06F 3/048; G06F 15/177

(52) U.S. Cl. 715/735; 715/771

(57) ABSTRACT

Described herein are various principles for assisting in the identification of a configuration of computing device and reconfiguration of the computing device. More particularly, some of the principles relate to identifying one or more software processes configured to be executed during operation of the computing device in a usage scenario. Following operation of the computing device in the usage scenario, amounts of one or more resources consumed by each of the software processes throughout the usage scenario may also be identified. In some embodiments, once the software processes and amounts of the resource(s) consumed by the software processes have been identified, the processes and the amounts can be displayed to a user and the user may then reconfigure the computing device, such as by preventing some software processes from executing during the usage scenario or by delaying an execution of some software processes.

### BACKGROUND

Users of computing devices expect timely operation of those computing devices and timely completion of tasks performed by the computing devices. Users are often frustrated when a task takes longer than expected. Such frustration may lead to the user developing a negative impression of a manufacturer of hardware of the computing device and/or a developer of software installed on the computing device.

Reducing or eliminating such negative impressions is clearly desirable for these manufacturers and developers. For many tasks, however, the timeliness of execution of the task by the computing device depends more on other software installed on the computing device and that is executing concurrently with performance of the task than on the manufacturers' hardware or the developers' software. Each piece of software that is executing during the task consumes resources of the computing device. In some cases, these other pieces of software compete for resources, like processor time and transfers of data from disk. Resource consumption by these other pieces of software lengthens the execution time for each of these pieces of software, as the software delay each other. Delay in the completion of execution of these pieces of software also delays completion of the task, which causes the user's frustration.

### SUMMARY

Manufacturers and developers would benefit from reduction of delays caused by software (including third-party software) executing during operation of a computing device in a usage scenario. For example, by preventing some software processes from executing or delaying execution of software processes in the usage scenario, some reduction in delay may result. However, manufacturers and developers do not have access to computing devices in a way that would allow them to reconfigure the software. Users have such access, but are not equipped with the knowledge or tools necessary to make such change. Some conventional tools exist that enable users to view software configured to execute during a usage scenario. However, these conventional tools only inform the user of which software will execute and do not assist a user in determining how to reconfigure the computing device to improve performance.

Described herein are various principles for assisting in the identification of a configuration of computing device and reconfiguration of the computing device. More particularly, some of the principles relate to identifying one or more software processes configured to be executed during operation of the computing device in a usage scenario. Following operation of the computing device in the usage scenario, amounts of one or more resources consumed by each of the software processes throughout the usage scenario may also be identified. For example, in some embodiments, an amount of processor time, an amount of data retrieved from disk, an amount of data transmitted or received via a network adapter, an amount of allocated memory, or other amounts of resources may be identified. To identify amounts, total amounts, average amounts, peak amounts, or other amounts may be identified. In some embodiments, once the software processes and amounts of the resource(s) consumed by the software processes have been identified, the processes and the amounts can be displayed to a user. Through viewing the amounts of the resources consumed by each process during the usage scenario, the processes that are using a lot of resources and/or a relative resource consumption between processes can be identified. In some embodiments, the computing device may then be reconfigured to affect performance of the computing device in the usage scenario, such as by preventing some software processes from executing during the usage scenario, by delaying an execution of some software processes, and/or by reconfiguring a priority (e.g., an execution priority for threads or a disk input/output priority) of some software processes. These changes may be made automatically or manually by a user. For example, a user may prevent a software process that is using a relatively large amount of resources from executing.

In one illustrative embodiment operating according to some of the principles described herein, a computing device may be configured to execute one or more “startup” processes during a startup or logon scenario. As part of the startup or logon scenario, the computing device will begin executing the startup processes and these processes will consume resources. Using techniques operating according to at least some of the principles described herein, a user may be provided with a listing of the startup processes as well as resources consumed by each startup process. The user may then be able to prevent or delay execution of a startup process or reconfigure a priority of a startup process to reduce delays of execution of the startup or logon scenario.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of one exemplary system in which some embodiments may operate;

FIG. 2 is a flowchart of one exemplary process for collecting information on resource consumptions of software process and changing a configuration of a computing device based on user input;

FIG. 3 is a flowchart of one exemplary process for identifying one or more software processes executing during a usage scenario;

FIG. 4 is a flowchart of one exemplary process for configuring a computing device to collect information regarding resource consumption of one or more processes;

FIG. 5 is a flowchart of one exemplary process for determining amounts of resources consumed by one or more software processes;

FIG. 6 is a flowchart of one exemplary process for determining amounts of resources consumed by a parent process based at least in part on a resource consumption of a child process;

FIGS. 7A, 7B, and 7C are flowcharts of exemplary techniques for modifying a configuration of a computing device, based on user input, so at to change software processes that execute during a startup scenario; and

FIG. 8 is a block diagram of one exemplary computing device with which some embodiments may operate.

### DETAILED DESCRIPTION

A configuration of a computing device typically governs the software processes that are executed or that are to be executed during a usage scenario. For example, a configuration of a computing device may govern what software processes to execute during a startup or logon scenario for the computing device. Accordingly, by changing this configuration, the software that executes during a usage scenario and the resources consumed by that software can be changed, which may reduce delays in completion of the usage scenario or completion of tasks.

However, changing the configuration of a computing device to affect performance may not be simple in many cases. For example, when a computing device is in the possession of an end-user, the user may install hardware/software or take other actions that have an impact on the configuration of the computing device. The end-user may not, however, have sufficient knowledge to change the configuration of the computing device to affect performance, including by improving performance. Because access by manufacturers and developers to a computing device possessed by an end-user is limited, manufacturers and developers would have difficulty changing a configuration of that computing device. Thus, when the computing device is in the possession of the end-user, making changes to the configuration to affect performance may be difficult.

This problem is not limited to computing devices in end-users' possession, though. Changing the configuration may be similarly difficult before the computing device is provided to an end-user. Access to a computing device may be somewhat easier for manufacturers/developers but, once design of the computing device is finalized and the device is put into production in a factory, the computing device may not be handled by workers skilled at configuring the computing device. The designers may have the ability to change the configuration before the computing device is in production, but may not have the ability to change the computing device during production. This may be a problem because changes may be made to the configuration on the factory floor, during production. For example, some factories may install additional software on a computing device, like application programs that the manufacturer agreed to install, for which the designers did not plan and that may change the configuration of the computing device from what was intended by the designer. Because these installations are done at production time, when workers are not skilled at making configuration changes, making further changes to the configuration to affect performance would be difficult.

Changes made to the configuration by factory workers or other users during production may therefore degrade performance of the computing device, such as by degrading performance during usage scenarios. These same factory workers, however, may not be skilled at configuring the computing device or making further changes to affect or improve performance.

Thus, manufacturers and developers may not have access to a computing device in a way that would allow them to easily manipulate a configuration. Users (including end-users and factory workers) may have access to the computing device but may not have the knowledge useful and/or necessary for making such changes. Such knowledge may include knowledge of how to identify which processes are using a lot of resources, which processes are using resources in a way that interferes with other processes, and which processes can be configured differently, as well as knowledge of how to reconfigure the computing device to change the processes and/or resources consumption levels.

Some tools exist that permit users to identify software that will execute during a startup scenario for a computing device. Such tools, however, merely provide the user with a list of the software that will execute during the startup scenario. These tools do not provide a great deal of assistance to users that lack the knowledge useful for reconfiguring the computing device. Thus, even users that are aware of such tools are typically not able to reconfigure their computing devices in a meaningful way to achieve some improvement.

Users could, however, benefit from a tool that identifies software processes executing during a usage scenario and provides some additional information that would allow the users to identify which software processes are impacting performance of the computing device. Users could apply this information to make changes to the configuration of the computing device regarding specific software processes identified by the tool, based on the performance impacts. Such a tool could be implemented in various ways, including as an application program, a plug-in, or a service/daemon, among other ways.

Automated analysis of operations of a computing device executed during a usage scenario could provide some information on software processes and performance impacts. For example, each software process executing during a usage scenario consumes some resources of the computing device and the performance impact of the software process may be related to the amount of resources consumed. Analysis of information regarding resources consumed by software processes during a usage scenario could provide information that would enable users to make changes to configurations of their computing devices, so as to improve performance during usage scenarios.

Described herein are various principles for assisting in the identification of a configuration of computing device and reconfiguration of the computing device. More particularly, some of the principles relate to identifying one or more software processes configured to be executed during operation of the computing device in a usage scenario. Following operation of the computing device in the usage scenario, amounts of one or more resources consumed by each of the software processes throughout the usage scenario may also be identified. For example, in some embodiments, an amount of processor time, an amount of data retrieved from disk, an amount of data transmitted or received via a network adapter, an amount of allocated memory, or other amounts of resources may be identified. To identify amounts, total amounts, average amounts, peak amounts, or other amounts may be identified. In some embodiments, once the software processes and amounts of the resource(s) consumed by the software processes have been identified, the processes and the amounts can be displayed to a user. Through viewing the amounts of the resources consumed by each process during the usage scenario, the processes that are using a lot of resources and/or a relative resource consumption between processes can be identified. In some embodiments, the computing device may then be reconfigured to affect performance of the computing device in the usage scenario, such as by preventing some software processes from executing during the usage scenario, by delaying an execution of some software processes, and/or by reconfiguring a priority (e.g., an execution priority for threads or a disk input/output priority) of some software processes. These changes may be made automatically or manually by a user. For example, a user may prevent a software process that is using a relatively large amount of resources from executing.

In some embodiments, automated analysis is carried out based on analyzing operations of a computing device in a usage scenario. A usage scenario is a set of activities or types of activities that can be carried out by the computing device. In some cases, a usage scenario may be a set of activities or types of activities to achieve a goal or a type of goal. Startup, shutdown, resuming from standby, starting an application program, and executing an application program are examples of usage scenarios for which a performance analysis tool may be provided.

Additionally, in some embodiments, resources consumed by software processes executing during a usage scenario are identified. The amount of resources that is identified may be any suitable measure of consumption, including total amounts over time, average amounts over time, peak amounts over time, rates over time, bandwidths, or any other amounts. Further, amounts of any suitable resource may be identified. Processor time, data transferred from high-latency storage (e.g., disk), data transmitted or received via a network, memory allocation, or other resources may be consumed.

In examples below, for ease of description, the usage scenario will be described as a startup scenario. A startup scenario may include, for example, operations carried out following a power-on of a computing device and a logon scenario may include, for example, operations carried out following a user's request to access the computing device using a user account. Additionally, in these examples, the resources will be described as processor time and data transferred from high-latency storage. However, it should be appreciated that embodiments are not limited to operating with a startup scenario and that other usage scenarios may be analyzed, and that embodiments are not limited to measuring processor time and data transfers or to measuring any other particular resources.

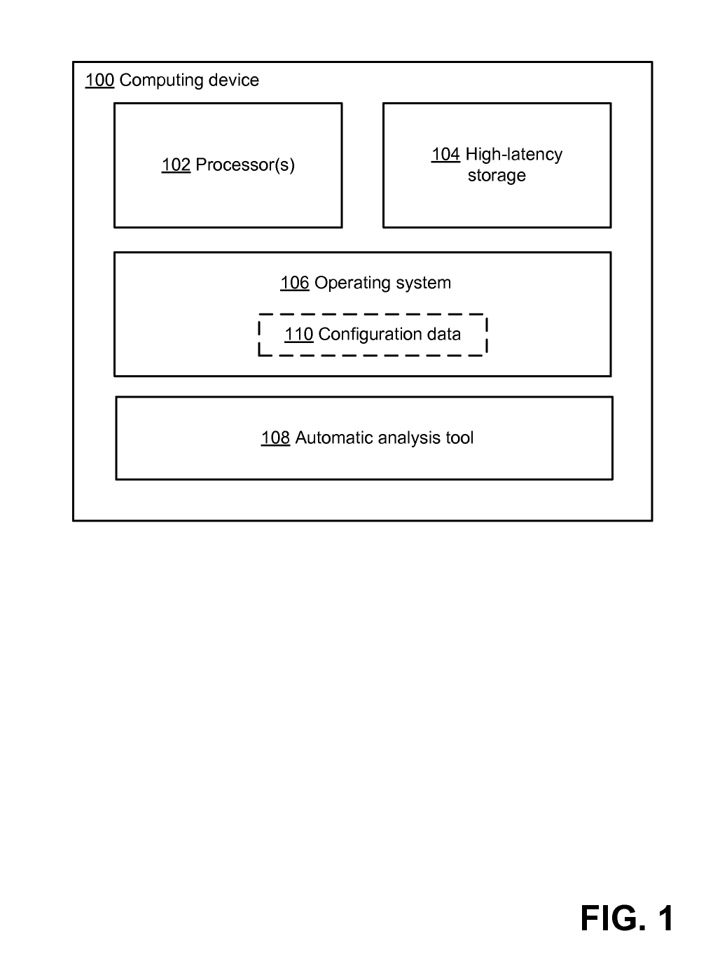

FIG. 1 shows a block diagram of one exemplary computing device with which some embodiments may operate. The computing device 100 of FIG. 1 includes at least one processor 102, at least one high-latency storage 104, and an operating system 106, and an automated analysis tool 108. Operating system 106 and automated analysis tool 108 may be stored on the high-latency storage 104 and/or on another storage medium, but are illustrated separately in FIG. 1 for ease of representation. High-latency storage 104 may be any suitable storage medium with a relatively large time to read and write operations, as compared to on-processor caches. As one example, high-latency storage 104 may be or include a magnetic disk drive like a hard drive.

During operation of the computing device 100 in a startup scenario, the operating system 106 may carry out various operations to ready the device 100 for user interaction, including displaying a user interface. The user may be waiting for completion of the startup scenario to be able to use the device 100 and may be frustrated by any delays. However, as discussed above, delays may be inserted based on the configuration of the device 100. For example, various startup processes may begin executing and consume resources of the computing device 100. The software processes may consume time on the processor 102 and may read data from or write data to the high-latency storage 104. Using time on the processor 102 means that some delay is created during context switching of the processor to switch from executing one process to executing another and some delay is created because other processes (like processes of the OS 106 to make the device 100 ready for the user) are prevented from completing sooner than they might otherwise if those processes were able to use more time on the processor 102. Similarly, because high-latency storage 104 has a long time to completion for read/write operations, any read/write operations carried out by the software processes may delay other processes (like process of OS 106) from performing read/write operations. And, as the high-latency storage 104 has only a limited amount of bandwidth for transferring data, read/write operations carried out by the startup processes consumes available bandwidth and thereby prevents other processes from using the available bandwidth. If those other processes are waiting for the read/write operations to complete, then those other processes will be delayed, which could create delay for the user.

FIG. 1 illustrates OS 106 including configuration data 110. The configuration data 110 may include information on which software processes are to be executed during a startup scenario. During the startup scenario, the OS 106 may examine the configuration data 110 and cause the computing device 100 to begin executing each of the listed software processes. Any suitable software may be configured to be started during the startup scenario. For example, the software processes may include user applications, including third-party applications, that the computing device 100 is configured to execute during the startup scenario. For example, many third-party applications may configure the computing device 100 to start, during the startup scenario, an update application that checks for whether there are any updates available for the third-party application. By doing so, the third-party application is able to receive any fixes for bugs or security breaches in a timely manner, such as when the computer is next connected to the Internet during a startup scenario. However, this update application consumes resources during the startup scenario. Other third-party applications may also be configured to execute at startup, such as messaging or media applications or any other application. These applications may themselves configure the computing device 100 to execute the applications during the startup scenario, or a user may configure the computing device 100 to execute the applications. Other software that may be configured to begin executing during the startup scenario includes operating system services (also called daemon processes), device drivers, and others.

The form of the configuration data 110 may vary, as embodiments are not limited in this respect. In embodiments in which the operating system 106 is the Microsoft® Windows® operating system, available from the Microsoft Corporation of Redmond, Wash., the configuration data 110 may be implemented as part of the Windows® Registry. During a startup scenario, one or more processes of the operating system 110 may review the Registry, identify the software processes to be executed, and cause the computing device 100 to begin executing the software processes.

In accordance with principles described herein, the automated analysis tool 108 may be used to identify software processes executing during a startup scenario (or other usage scenarios) as well as resources consumed by the software processes. For example, the tool 108 may identify, for each software process indicated in the configuration data 110, an amount of time of the processor 102 used by the software process and an amount of data written to or read from high-latency storage 104.

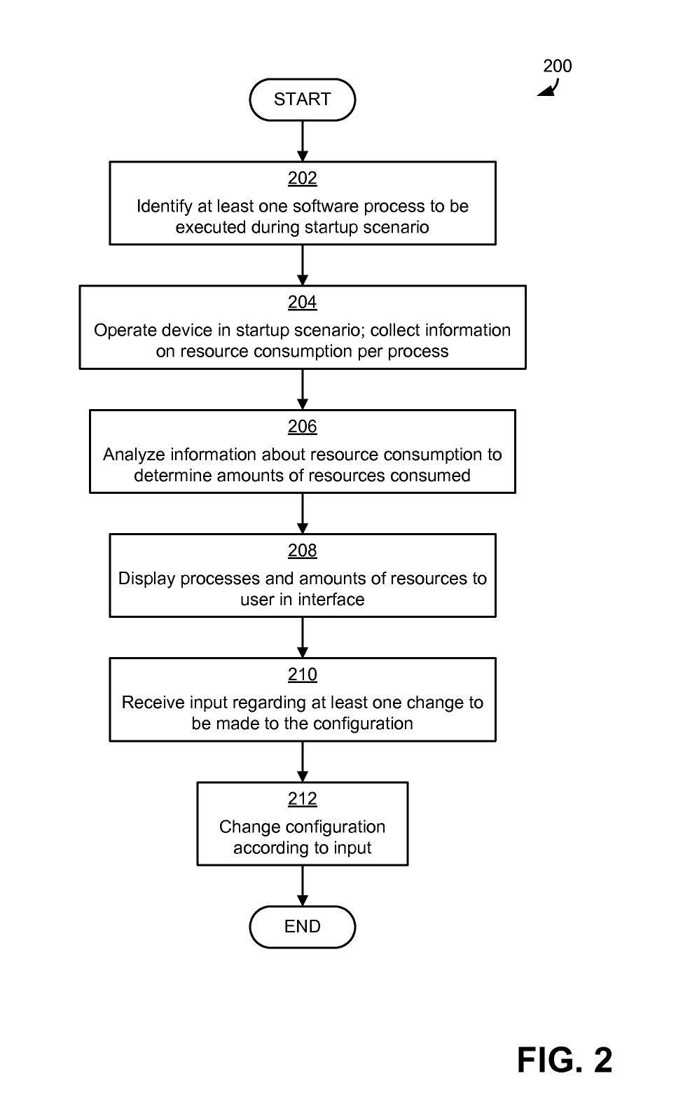

Automated analysis tool 108 may be implemented in any suitable way to identify software processes and amounts of resources used. FIG. 2 illustrates one technique that may be used in some embodiments by the tool 108.

Prior to the start of the process 200 of FIG. 2, an operating system has been installed on a computing device. Additionally, one or more other pieces of software, such as third-party user applications, services, device drivers, etc., have been installed on the computing device. The computing device has been configured to execute at least one piece of software as a software process during a startup scenario. For example, the computing device may be configured to execute at least one third-party user application during the startup scenario.

Process 200 begins in block 202, in which an analysis tool identifies, from configuration data of the computing device, at least one software process to be executed during the startup scenario. In some embodiments, this may comprise retrieving information stored by and/or managed by an operating system. For example, where the operating system is the Windows® operating system, the information may be a part of the Registry. Upon retrieving the information on the software processes to be run, an indication of the processes may be stored by the analysis tool.

In block 204, the computing device is operated in the usage scenario desired to be analyzed and data is collected on resources consumed by the software processes.

Operating the computing device in the usage scenario may be done in any suitable manner. For example, the analysis tool may automatically trigger the computing device to begin operating in the usage condition, such as by performing a restart operation such that a startup scenario can be observed and analyzed or starting up an application such that an application startup usage scenario can be observed. In other cases, though, the analysis tool can be set up to monitor and analyze the startup scenario and, next time the computing device enters the startup scenario (by user request or in any other way), the monitoring and analysis can be carried out.

Regardless of how the computing device enters the startup scenario, information about resources consumed by the software processes during the startup scenario may be collected. This information may be collected in any suitable form. In some embodiments, the information that is collected may be related to operations carried out by the software processes during the startup scenario, which may be analyzed to determine resources consumed by the processes.

In block 206, following operation of the computing device in the usage scenario and collection of information about resource consumption, the information about resource consumption may be analyzed for each software process. The information may be analyzed to determine amounts of resources consumed. For example, an amount of processor time and/or an amount of data transferred from a high-latency storage (e.g., a hard drive) may be identified. The amounts that are identified may be any suitable amounts. For example, a total amount, a peak amount over time, an average amount over time, rates over time, bandwidth, or other amounts of resources consumed may be identified.

In block 208, a user interface is provided to a user that lists the software process(es) that are configured to execute during the startup scenario as well as the amounts determined in block 206. In some embodiments, the user interface may also present some information to the user to enable to user to identify processes consuming large amounts of resources. For example, the software processes may be ranked in the list according to levels of resource consumption or each software process may be labeled in some way according to levels of resource consumption (e.g., labels for low, medium, or high). From this interface, the user would see not only the software processes contributing to delays during the usage scenario but also the levels of resources consumed by each software process. In this way, the user would be able to determine how to change a configuration of the computing device to improve performance. For example, the user could determine that processes consuming large amounts of resources should be prevented from executing during the usage scenario, so as to improve performance during the usage scenario. Thus, rather than blindly guessing at which software processes to adjust or how to reconfigure the computing device, the user is provided some information to aid the user in identifying changes to the configuration.

Accordingly, in block 210 an input is received from a user identifying at least one change to be made to the configuration to change the manner in which the software processes execute during the startup scenario. For example, the software processes may be changed, such as by preventing some software processes from executing. As another example, some software processes may be delayed during the startup scenario, such that the software process still executes during the usage scenario but executes at a later time. As a third example, a software process may be moved to another usage scenario and executed instead during that usage scenario. For example, rather than executing during the startup scenario the software process may execute following the startup scenario, during normal operation of the computing device. A fourth example of a change is changing a priority for the software processes, such that threads of the software processes will execute with a higher/lower priority or read/write operations for the storage 104 will be handled with higher/lower priority.

Regardless of the type of change requested by the input, in block 212 a change is made to the configuration of the computing device based on the input. The change may be made in any suitable manner, as embodiments are not limited in this respect. In some embodiments, the change may be made by directly editing configuration data of the computing device, such as by removing designated processes from a set of processes to be executed during a startup scenario. However, in some cases an application or other piece of software may undo such a change, such as by placing a removed process back into the list. Accordingly, in some other embodiments, additional or alternative changes may be made to a configuration of a computing device. For example, in addition to the list of processes to be executed during startup, an operating system may also maintain a whitelist or blacklist that indicates processes that should or should not be executed, regardless of whether the processes are present in the list of processes to be executed. When such whitelists or blacklists are used, during startup an operating system may evaluate the configuration list of processes to be executed during the startup scenario, but before causing any process to be executed, the operating system may review the whitelist or black to determine whether the process should be executed.

Once the change is made in block 212, the process 200 ends.

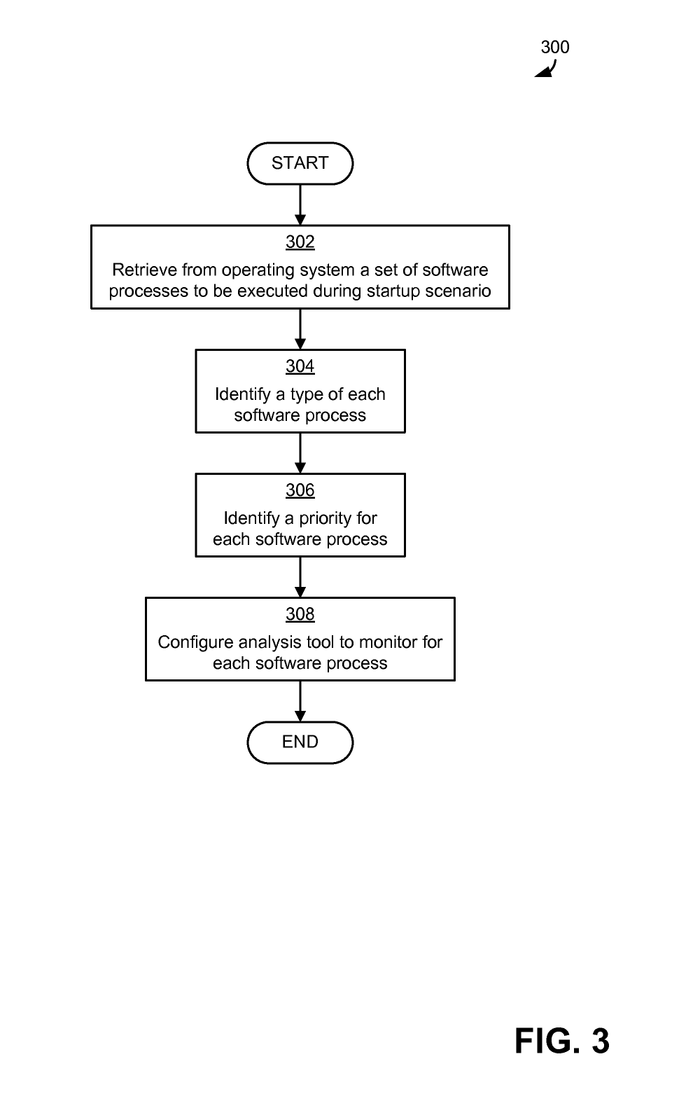

Each act of the process 200 of FIG. 2 was described generically, according to how some embodiments would implement these acts. Embodiments, however, may carry out these acts in any suitable manner. Exemplary ways of carrying out the acts indicated in FIG. 2 are discussed below in connection with FIGS. 3-7C.

FIG. 3 illustrates one exemplary technique for identifying at least one software process that is to be executed during a usage scenario. The process 300 of FIG. 3 begins in block 302, in which a listing of software processes to be executed during a startup scenario is retrieved from configuration data maintained by an operating system. As mentioned above, the software processes of the listing may include any suitable processes, including processes related to user applications, services (also called daemons), device drivers, and other pieces of software. In addition, the listing may be retrieved from any suitable source, as embodiments are not limited in this respect. In some embodiments, as mentioned above, the operating system may be the Windows® operating system and the listing may be retrieved from the Windows® Registry.

In some embodiments, an analysis tool may be configured to examine and analyze resource consumptions for only some of the software processes to be executed during a startup scenario. For example, the analysis tool may be configured to analyze only user applications or only processes that are likely to use large amounts of resources. Accordingly, in some embodiments the software processes contained in the listing retrieved in block 302 may be analyzed.

For example, in block 304 each of the software processes is analyzed to determine a type of the software process. Analyzing to determine the type may include determining whether the software process is related to a user application, service, device driver, etc., or may include determining whether the software process will execute in a user mode or a kernel mode of the computing device, or any other suitable determination.

In block 306, a priority for each of the software processes is identified. The priority may be used by a processor of the computing device to determine how and when to execute processes. For example, a priority may be used to determine which process to begin executing first (e.g., such that high-priority processes are executed first), in what order to continue executing instructions of processes (e.g., when choosing which set of instructions of currently-executing processes to execute next, the priority can be used to determine which process to select), and when to interrupt currently-executing processes to execute instructions of another process (e.g., such that high-priority processes can interrupt execution of lower-priority processes). As a result of the priority, high-priority processes can be executed first and/or more often. Each process to be executed may be associated with information regarding a priority that will be assigned when the process is first executed on the computing device and this priority information may be retrieved by the analysis tool in block 306 for use in the process 300.

In block 308, once the determinations of blocks 304 and 306, and/or any other suitable determinations, are made, then the analysis tool analyzes software processes during a startup scenario to identify a resource consumption. The analysis tool may be configured, in some cases, to analyze a limited set of processes, such as processes of a particular type or priority. For example, the analysis tool may be configured to analyze a resource consumption of processes related to user applications and that are high priority. This may be done because user applications may often consume resources in such a way that causes delay during a startup scenario, but may not provide much benefit to a user. By identifying these processes to a user, the processes may be changed in response to user input, as described below. Additionally, high priority applications may have a greater impact on resource consumption than processes with lower priorities. The impact on resource consumption relates not only to the time that the high-priority process spends executing on the processor, thereby delaying other processes, but also to the time the processor spends switching between processes (e.g., changing instructions and changing data stored in memory), as the processor may be adapted to switch to high-priority processes from lower-priority processes when a high-priority process is ready to be executed.

The configuration of block 308 may be carried out in any suitable manner, as embodiments are not limited in this respect. In some cases, the analysis tool may be configured by the input of identifiers for the processors to be analyzed. The analysis tool may then use this information to collect information on resource consumptions, as discussed below.

Once the analysis tool is configured in block 308, the process 300 ends.

To collect information on resources consumed by software processes during a startup scenario, the computing device can be operated in the startup scenario and information about resource consumptions can be collected. The information about the resource consumptions may be collected in any suitable manner. In some cases, conventional tools for monitoring operations of processes executed by a computing device may be used to track resource consumption. For example, tracing tools, which track operations carried out by processes and that store information about the operations, can be used to track resource consumptions. The Event Tracing for Windows (ETW) functionality of the Microsoft® Windows° operating system, available from the Microsoft Corporation of Redmond, Wash., is an example of a tracing system that may be used in some embodiments. As part of ETW, instrumentation software that is a part of the operating system collects information about events that occur on the computing device. Information about the events may include information on resource consumption by the processes that cause the events to occur. Analyzing the information collected by tracing systems like ETW, then, may provide some information about resource consumption. Tracing systems like ETW are known in the art and will not be discussed further herein.

In some embodiments, an analysis tool may, for events corresponding to resources for which a consumption is to be tracked, request that a tracing system (e.g., ETW) activate tracing for those events for some pieces of software.

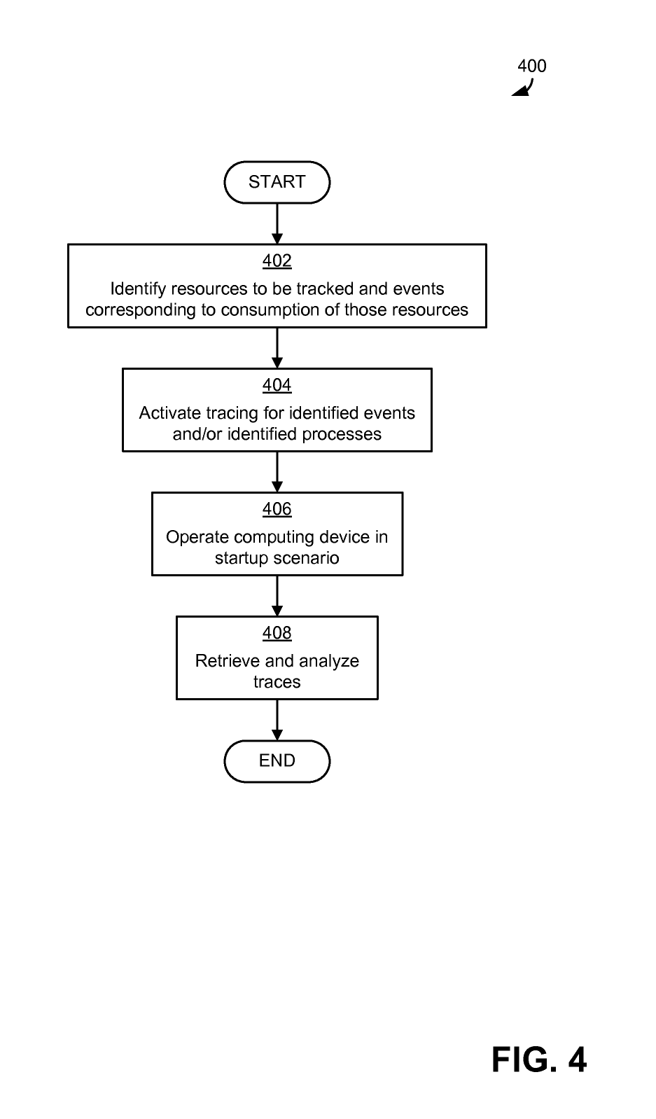

FIG. 4 illustrates one exemplary technique for collecting traces relating to consumption of resources on a computing device. The process 400 begins in block 402, in which an analysis tool identifies resources to monitor and events related to those resources. The identification can be based on user input and/or a configuration of the analysis tool. For example, the analysis tool maybe preconfigured to analyze consumption of particular resources or may receive input from a user regarding resources to analyze. Though, the analysis tool may be configured in any other manner, as embodiments are not limited in this respect. In addition, the analysis tool may identify (in any suitable manner, including the examples just described) events that indicate consumption of the identified resources. For example, when a processor switches between processes, the processor performs a context switch operation, which generates an event. If these events generated by the processor are tracked and analyzed, then a processor time used by a particular process may be determined. For example, one event may correspond to a start of processing for a process and a second event may correspond to an end of processing. The difference between times for these events would indicate a time that the process used the processor.

In block 404, tracing functionality is enabled for processes of interest and/or for events identified in block 402. When the tracing functionality is activated, occurrence of an event results in storage of data related to the event, such that the data may be later analyzed.

Once the tracing functionality is enabled for the processes and/or events, then data regarding consumption of resources by the process(es) may be collected. The data may be collected through the event tracing functionality described above. In some embodiments, the information on resource consumption may be collected through operation of the computing device in the startup scenario, such that realistic resource consumptions of each software process can be identified. Accordingly, the computing device may be operated in the startup scenario in block 406. To do so, the analysis tool may trigger a restart operation of the computing device or may configure the computing device to begin executing the analysis tool next time the computing device is restarted. During the operation of the computing device in the startup scenario, operations of the startup scenario are carried out, including operations of the software processes configured to execute during the startup scenario. As the operations of the software processes are carried out, events occur and traces corresponding to the events are generated and stored by the ETW system (or other tracing tool).

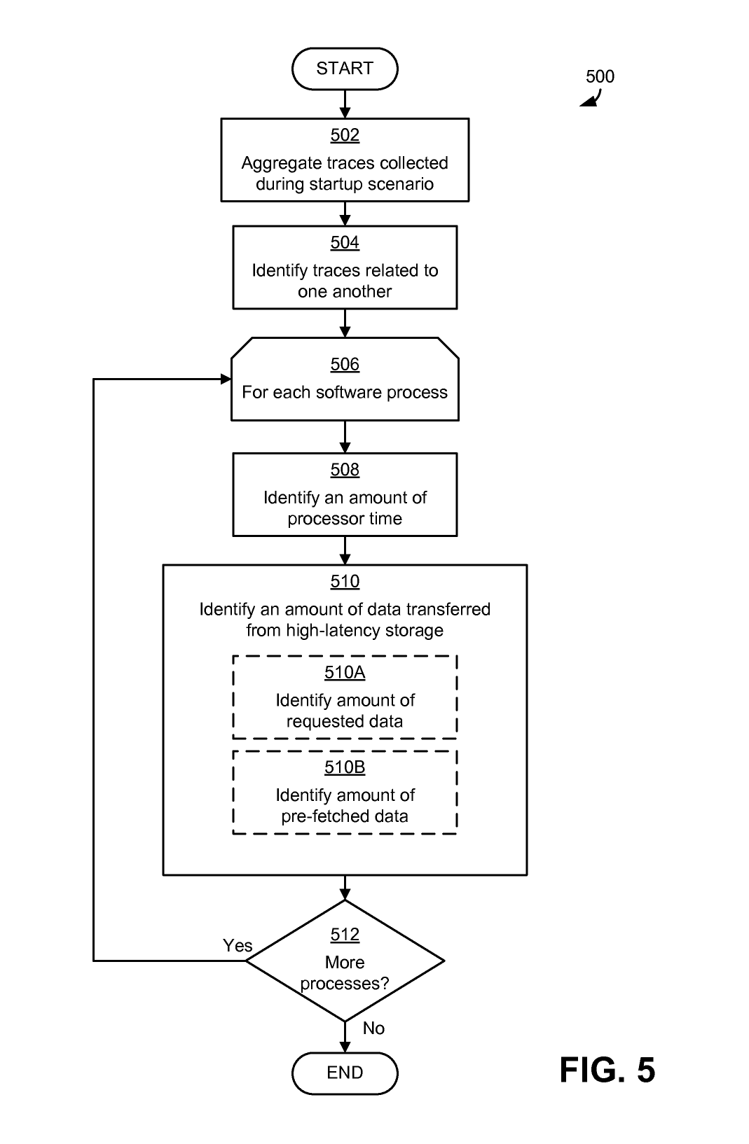

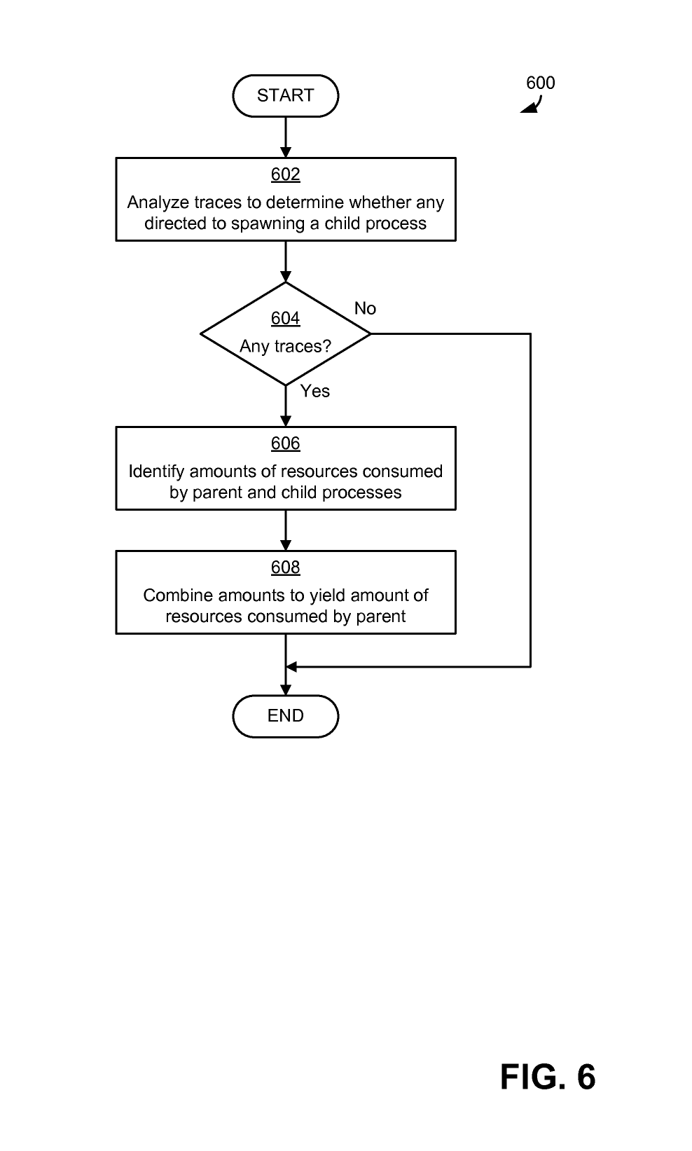

In block 408, following operation of the computing device in the startup scenario, the traces generated in block 406 are retrieved by the analysis tool and are analyzed by the analysis tool. The traces may be analyzed in any suitable manner, examples of which are described below in connection with FIGS. 5 and 6.

Once the traces have been retrieved and analyzed, the process 400 ends.

Traces may be used to identify amounts of resources consumed by software processes. However, the traces may not immediately identify these amounts; the amounts may result from an analysis of the traces.

As discussed above, different amounts of resource consumption may be calculated in different embodiments: a total consumption of some resource, average consumption over time during the startup scenario, peak consumption over time, etc. Any suitable measurement of resource consumption may be used in embodiments. Further, as consumption of resources may be better identifiable using some measurements than others, in some embodiments different measurements may be used for different resources.

As the resources to be measured and the type of analysis to be carried out may vary between embodiments, embodiments are not limited to performing any particular analysis technique on traces collected during operation of the computing device in the startup scenario. Rather, any suitable analysis can be carried out. FIG. 5 illustrates one exemplary technique that may be used to identify amounts of resources consumed by each software process during a startup scenario.

The process 500 begins in block 502, in which the analysis tool aggregates for analysis the traces collected during a startup scenario. In block 504, the analysis tool first analyzes traces to determine which traces are related to one another, such as by identifying all the individual traces that correspond to a particular software process. By aggregating the traces and identifying which relate to the same process, the amounts of resources consumed by the software process can be more easily identified. In some embodiments, the traces may each include an identifier for a process to which the traces relate, such as a process identifier assigned by the computing device during the startup scenario. This process identifier may be used to identify traces that correspond to one another.

In block 506, the analysis tool begins a loop for each software process. In some cases, the loop may iterate through each of the software processes identified in configuration data stored by the operating system. In other cases, though, some software processes identified in the configuration data may not execute during all startup scenarios. As such, the loop may iterate through software processes identified in the traces in block 504.

Within the loop of block 506, the analysis tool identifies amounts of resources consumed by the currently-selected software process. In the embodiment of FIG. 5, amounts of two resources are identified for each software process: processor time and data requested from high-latency storage. Further, in this embodiment, the amount identified for each is a total amount. However, any suitable resources and measures of amounts may be used.

In block 508, the analysis tool reviews the traces related to the software process to determine which traces correspond to events indicating a use of the processor by the software process. These events may include context switches in which the processor switched to executing the software process and context switches in which the processor switched away from executing the software process. These events may be paired to identify events corresponding to a start and an end to executing of the software process. There may be multiple pairs of these events, as the processor may have switched between multiple different processes over time during the startup scenario, rather than executing one process to completion before executing another process. By calculating, for each pair, a difference between a stop time and end time and summing these differences, a total time that the software process was executing on the computing device may be identified.

In block 510, the analysis tool reviews traces related to the software process to determine a total amount of data transferred from a high-latency storage. A high-latency storage may be, for example, a hard disk drive. When a process requests data that is stored on disk and disk manager software retrieves the data from the disk, the disk manager software raises an event corresponding to the retrieval. The trace for the event includes an identifier for the process for which the data was retrieved. Accordingly, in block 510A, traces for events raised by disk manager software that indicate an amount of data retrieved for the currently-selected software process may be reviewed. These amounts may be summed to determine a total amount of data retrieved for the software process.

In some embodiments, reviewing the events raised by the disk manager software can identify all data requested on behalf of a software process. In other embodiments, however, these events may not identify all data requested from high-latency storage on behalf of a software process. In some computing devices, a large amount of data is transferred from high-latency storage for one or more software processes during a startup scenario, and these transfers from high-latency storage may delay software processes and delay the startup scenario. Some computing devices therefore include software to monitor software processes over time and identify data that the software processes are likely to request. The identified data may then be added to a “pre-fetch” list. Data on the pre-fetch list may be requested at times that other data is not being requested from disk, such that data that is likely to be requested later can be retrieved during periods when no data is being retrieved. Once retrieved, the data can be placed in a low-latency memory cache. Subsequently, when the data is requested by a software process, the data can be provided quickly from the low-latency memory cache, rather than being retrieved slowly from the high-latency storage. The software process requesting the data can then continue executing sooner than the process may otherwise, as the data may have been returned more quickly. The ReadyBoot system, available from the Microsoft Corporation of Redmond, Wash., is one example of such a pre-fetch system.

In computing devices that use such a “pre-fetch” model, examining only the traces and events generated by the disk manager software may not provide an accurate amount of data transferred from disk by a software process. The pre-fetch data, while retrieved before the software process requested the data, was requested on behalf of the software process and used by the software process. A more accurate amount of data transferred from high-latency storage by the software process would include this pre-fetch data. In some embodiments, therefore, additional events are considered. These events may have been raised by a cache manager software in response to data, stored in a cache, being provided to a software process. As the pre-fetch data would be stored in the cache, any indication that data was successfully provided from the cache would indicate that previously-retrieved data is being used by the software process. In embodiments, events are generated in response to cache hits, and these events generate traces. The traces associated with a cache hit event include a process identifier that corresponds to the processor that retrieved the data from the cache.

Accordingly, in block 510B, traces corresponding to cache hits are identified. From each cache hit trace, a process identifier contained in the trace is identified and the amount of data that was retrieved from the cache is identified.

The amounts identified in blocks 510A and 510B can be added to yield an amount of data requested from high-latency storage for the software process.

Once the amount of data is calculated in block 510, the process 500 continues to block 512, in which a determination is made as to whether any more software processes remain to be considered in the loop of block 506. If so, then the loop continues back to block 506 and a new software process is selected. Otherwise, the process 500 ends.

In some embodiments, identifying the amount of data requested from high-latency storage for a process may include identifying amounts of data read by a read-ahead cache manager on behalf of a process. As discussed above, pre-fetching systems that identify patterns in read operations conducted in previous scenarios to read data in a current scenario before the data is requested. Read-ahead systems, on the other hand, may observe patterns in the read operations conducted by a process in a current scenario and identify data that may soon be requested by the process, and read the data before the data is requested. For example, the read-ahead system may identify a pattern of read operations conducted for small, sequential portions of data and may preemptively read a large amount of sequential data into a cache to be prepared for the next small read operation. When the next small read operation is performed by the process, the data requested by the read operation will be in the cache as a result of the read-ahead operation and therefore can be serviced more quickly than by conducting a read operation to the high-latency storage. When such a read-ahead system is used in embodiments, data requested by the read-ahead system on behalf of a process can be identified through identifying cache-hits. For example, in some embodiments the techniques used for identifying data requested by a pre-fetch system through identifying cache hits can be used to identify data requested by a read-ahead system. Though, embodiments are not limited to using these exemplary techniques as others are possible.

In the example given above, each of the processes executing on a computing device during a startup scenario is treated independent of other software processes, and amounts of resources are calculated separately. However, in some cases, two processes executing on a computing device may not be independent of one another. Rather, in some cases, two processes may be related in some way, such as a parent process and a child process. A child process is one that begins executing when a parent process requests that a child process be spawned. Typically, a child process carries out some operations related to or on behalf of the parent process, so as to relieve the parent process of some processing burden. During execution, the child process may exchange information with the parent process such that both may continue operation.

As a result, in some cases, two processes may not be independent of one another, but instead may be related in some way. In these cases, the resources consumed by the child process could be fairly attributed to the parent process, as the parent process is benefitting from spawning the child process. In some embodiments, therefore, an analysis tool may identify from the traces a parent process and a child process and combine the amounts of the resources consumed by both to give a more accurate perspective on resource consumption by the processes through the combination.

FIG. 6 illustrates one exemplary technique that may be implemented in some embodiments to attribute resource consumption of one or more child processes to a parent process. The process 600 of FIG. 6 begins in block 602, in which an analysis tool analyzes traces related to a software process to determine whether traces indicate any events that create a child process for a parent process. If the analysis tool determines in block 604 that no such trace exists, then the process 600 terminates. If, however, the analysis tool determines in block 604 that one or more child processes exist for parent processes, and that identifies both the parent process and the child processes (such as by a process identifier) for each of these relationships, then these relationships may be acted on by the process 600. For each relationship identified between a parent and child process, including nested relationships (e.g., a parent, a child, and a sub-child of the child process), the relationship may be noted such that resources can be properly attributed to parent processes. Once the relationships are identified, the process 600 continues to block 606.

In block 606, the analysis tool identifies amounts of resources consumed by all processes, including parent processes and child processes, such as by using any of the exemplary techniques described above. In block 608, using the relationships between parent and child processes identified above, the amounts of resources for each set of parent and child are summed to yield an amount of resources consumed by the parent process during the startup scenario. In some embodiments that permit child processes to spawn further child processes to form multiple levels of a hierarchy, resources consumed by all children of a root parent process may be attributed to the root parent process in block 608.

Once the resource consumption for each parent process is identified in block 608, the process 600 terminates.

As discussed above, the software processes executing during the startup scenario and the amounts of resources consumed by each software process are identified such that changes can be made to the software processes that could result in performance enhancements for the startup scenario. These changes may be made automatically, based on criteria that can be set for an automated process for making changed to the software processes, or may be made manually by a user.

In some embodiments, therefore, once the processes and amounts are identified by the analysis tool, the processes and amounts may be stored in a data structure (e.g., an Extensible Markup Language (XML) file) and displayed to a user via a user interface. The software processes that execute during the startup scenario may be displayed in the user interface as a list along with the amounts of resources consumed by each software process, and this list may be sorted according to a level of resource consumption for the software processes. By sorting the list of processes in this way, the user may be better able to identify software processes that have a significant impact on performance of the computing device during the usage scenario and thus be better able to identify changes to be made that could impact performance.

The software processes may be ranked according to resource consumption in any suitable manner. If consumption of just one resource is measured, the software processes may be sorted according to a consumption of that resource. If consumption of multiple resources is measured, however, some other technique may be used. For example, the software processes may be sorted according to a consumption of one resource. As another example, an overall level of resource consumption may be determined for each software process based on a calculation involving the amounts of each measured resource. Such a calculation may be performed in any suitable manner, including by weighting amounts for particular resources in any suitable way.

In some embodiments, such as embodiments in which an overall level of resource consumption is calculated, the user interface may also include for each software process a label identifying a level of resource consumption for the software process, including a low, medium, or high consumption or other suitable label.

In addition to displaying the list of software processes and the amounts of resources consumed by the software processes, the user interface may also permit a user to make changes to the software processes and to the startup scenario. For example, the user interface may permit the user to make changes to which software processes execute during the startup scenario and/or to when the software processes execute. In some embodiments, a user may be permitted to make four types of changes to the software processes and startup scenario. First, the user may be able to prevent a software process from executing in subsequent startup scenarios by reconfiguring the computing device such that the software process is not executed. Second, the user may be able to change a time at which a software process executes, such that a software process could be delayed and execute at a later time than the software process otherwise is or execute only occasionally. Delaying the software process may enable some other process or operation executing during the startup scenario to complete more quickly, without being interrupted or delayed by the software process. Executing the software process only occasionally—for example, once a week, once a month, etc.—prevents the software process from interrupting or delaying other software processes regularly. Third, the user may be able to regroup a software process, such that the software process is executed during a different usage scenario. For example, the user may change a software process from executing during a startup scenario to executing later, such as during normal usage of the computing device by a user after the startup scenario. Fourth, the user may be able to change the priority assigned to a process, such as the execution priority assigned to threads of the process or the operation priority assigned to read/write operations conducted on behalf of the process with respect to a high-latency storage. The priority that is assigned to a process may be stored in a data store of the computing device, such as an operating system data store, and may be altered in response to user input to make changes to the process.

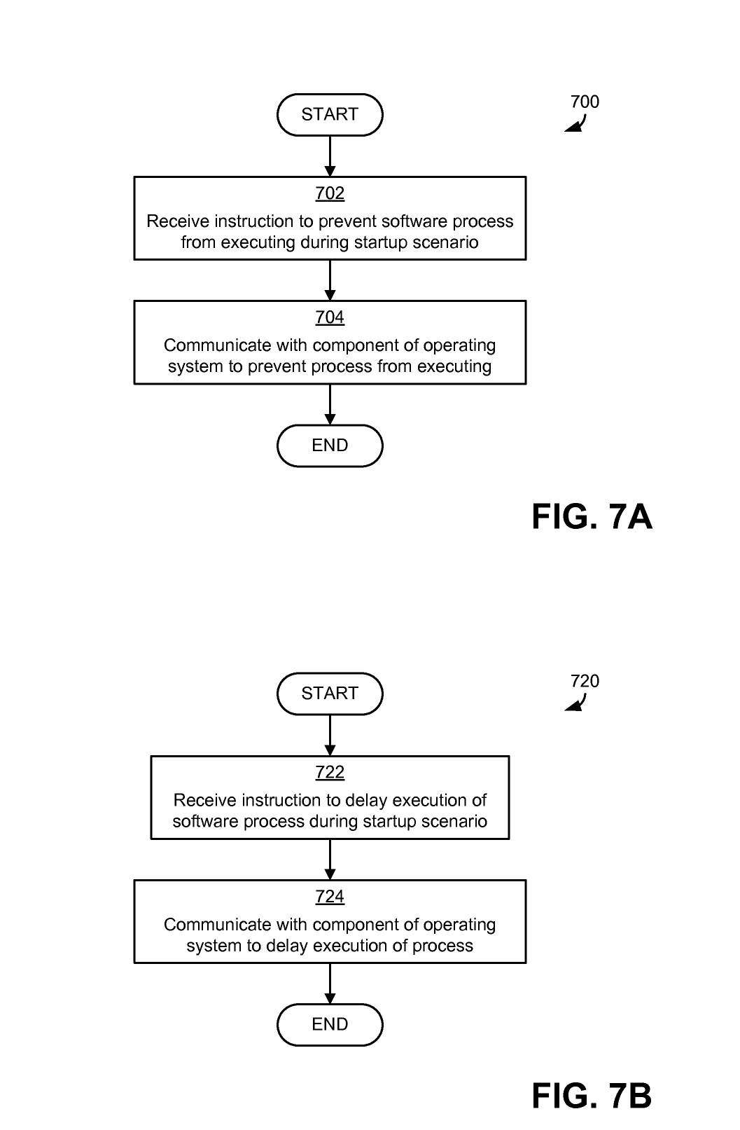

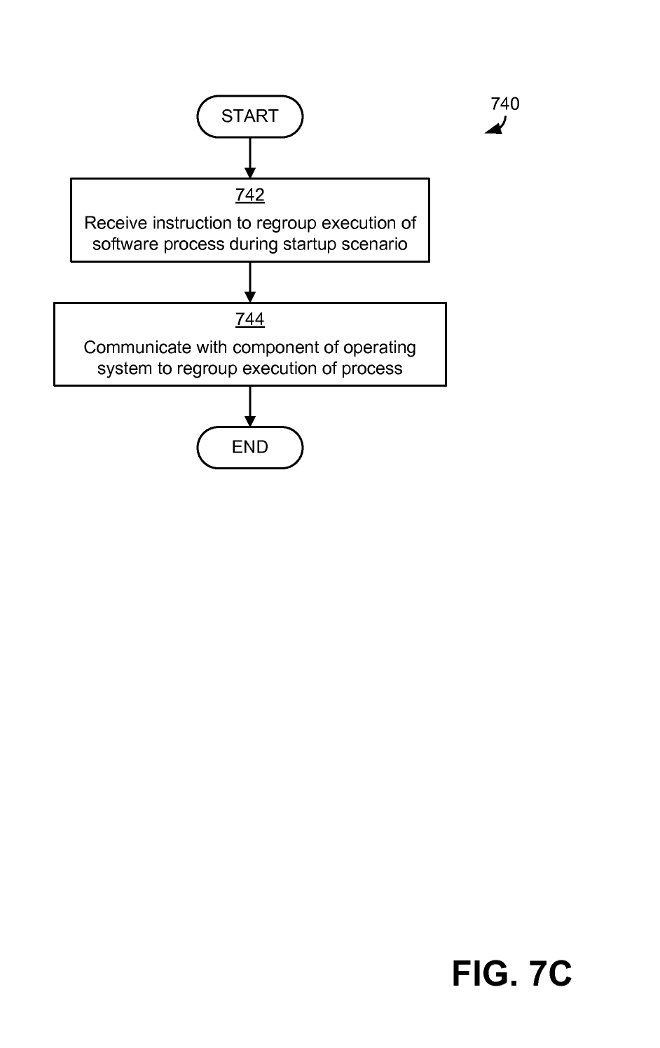

FIGS. 7A, 7B, and 7C respectively show three techniques for changing a configuration of a computing device based on user input received via the interface. Embodiments that change a configuration of a computing device based on user input are not limited to implementing any of these or other techniques for changing the configuration.

FIG. 7A illustrates one exemplary process for preventing a software process from executing during a startup scenario. In some embodiments, a software process may be removed from the startup scenario merely by removing the software process from configuration data stored by the operating system. However, such a technique may not always be effective, as applications related to the removed software process may subsequently re-insert the software process into the list of software processes to be executed in the startup scenario. The process 700 of FIG. 7A can overcome this problem by leaving the software process in the configuration data of the operating system but separately preventing the software process from executing.

The process 700 begins in block 702, in which the analysis tool receives an instruction from a user indicating that a software process is to be prevented from executing in a startup scenario for a computing device. In block 704, the analysis tool communicates with a component of an operating system of the computing device that triggers execution of software processes during a startup scenario. The analysis tool provides the component with an identifier for the software process and instructs the component to ignore the configuration data and not to execute the software process. Once the component is configured with the instruction of block 704, the process 700 ends.

FIG. 7B illustrates an exemplary process for delaying execution of a software process during a startup scenario. In some embodiments, to schedule execution of a software process, the software process may be removed from the set of software processes to be executed during the startup process and instead scheduled for execution using separate task scheduling software of the operating system of the computing device. This approach, however, suffers from drawbacks similar to those discussed in connection with FIG. 7A—namely, an application later undoing changes made to the configuration. The process 720 of FIG. 7B can overcome this problem by leaving the software process in the configuration data of the operating system but separately enforcing a delay in execution.

The process 720 begins in block 722, in which the analysis tool receives an instruction from a user indicating that a software process is to be delayed from executing at a normal or typical time such that the software process executes at a later time. In block 724, the analysis tool communicates with a component of the operating system of the computing device that triggers execution of software processes during a startup scenario. The analysis tool provides the component with an identifier for the software process and instructs the component not to execute the software process until a condition is met. The condition may be lapse of an absolute time, like 500 milliseconds or 2 seconds, or may be a condition relating to other properties of the computing device, such as that the software process should not be executed until a user is not interacting with the computing device via the user interface. Once the component is configured with the instruction of block 724, the process 720 ends.

The user may identify changes to be made using the techniques above in any suitable manner. In some cases, the user may have some expertise or knowledge in this area and may be able to identify based on that expertise or knowledge how the processes could be changed to improve or affect performance of the computing device in the usage scenario. In other cases, a user may make changes through guessing or trial and error, making changes and observing the impact on the computing device and the usage scenario. In still other cases, a user may be guided by changes made by other users. For example, users may be able to transmit to a central server or other location information regarding changes that have been made to their system. The changes transmitted may be all changes made by the users or changes that the users deemed to be successful changes that impacted the performance of their computing devices. Information transmitted from the users may include information not only about the change made but also about the process(es) to which to the change was made. For example, users may be able to transmit information regarding which processes the users disabled and which processes the users delayed. Once provided to the central server or other location, this information can be distributed to users attempting to make changes to processes of usage scenarios. For example, an analysis tool may download the information and display the information to the user via the user interface. The information may be provided to the user when the user is attempting to make changes to the processes, such that the user can make changes based on the changes made by other users. For example, the user interface of the analysis tool may provide an indication to a user that nearly all users disabled a particular process, to prevent the process from executing, or that some users have delayed execution of a particular process. These indications may be displayed in the user interface closely with the processes to which they relate, such that a user viewing the user interface is able to take advantage of the recommendations of other users.

In some other embodiments, delaying of execution of software processes may be carried out in a different manner. Rather than identifying a particular time at which to start execution of a process, the computing device may be configured to start a next software process only after a first software process has completed execution or has ceased consuming a large amount of resources. By reducing the number of processes executing or using resources in parallel, each process may be able to use more resources during its execution and may therefore execute more quickly. Staggering processes may therefore improve performance of the computing device in the usage scenario. Therefore, in these embodiments, all processes or individual processes may be staggered, such that one process only begins executing after a previous process stops executing or has stopped consuming a large amount of resources (e.g., an amount of resources above a threshold).

FIG. 7C illustrates another exemplary process for changing a configuration of a computing device by regrouping software processes such that the processes execute during a different usage scenario. This is similar in some ways to the delaying discussed above in FIG. 7B. In fact, regrouping of software processes may be carried out using a task scheduler as discussed above, though the use of a task scheduler for regrouping software processes exhibits problems similar to those described above in FIG. 7B. The embodiment of FIG. 7C can fix that problem, however, as the process 700 of FIG. 7C can be used to delay execution of a software process such that the software process executes during a subsequent usage scenario.

The process 740 begins in block 742, in which the analysis tool receives an instruction from a user indicating that a software process is to be prevented from executing at a normal or typical time such that the software process executes during a different usage scenario. In block 744, the analysis tool communicates with a component of the operating system of the computing device that triggers execution of software processes during a startup scenario. The analysis tool provides the component with an identifier for the software process and instructs the component not to execute the software process during the startup usage scenario but to instead execute the software process as part of some other usage scenario. Once the component is configured with the instruction of block 744, the process 740 ends.

In some embodiments, in addition to providing to a user a user interface that displays resource consumptions for processes and enables the user to make changes to software processes, a second user interface may be provided that would enable users to track the impact of their changes. For example, in some such embodiments, the system may maintain metrics regarding performance of the system over time, such as a total time for completion of a scenario (e.g., a total boot time for a startup scenario). As the user makes changes to the software processes, the changes may impact the performance of the system and the metrics. By presenting the metrics to a user, such as in a line graph format, the user could observe how the changes made by the user have impacted the system. In some embodiments, the user interface may annotate the metrics or annotate times with information regarding changes made by the user, such as by noting times that a user made particular changes to software processes.

In the example above, a user is provided the ability to make changes to software processes so as to affect performance of a computing device in a usage scenario. In some embodiments, in addition to or as an alternative to such manual changes, the analysis tool may be able to make changes automatically. The analysis tool may be able to make changes in ways that the user is able to make changes, including disabling processes, delaying processes, regrouping processes, and changing the priority of processes. The analysis tool may be configured to make these changes based on any suitable criteria. For example, the analysis tool may make changes to processes with the highest relative resource consumption or make changes to processes with resource consumptions above a threshold. In some cases, the analysis tool may maintain information regarding processes which should or should not be changed, such as processes associated with applications that a user often uses, processes that carry out operations that impact the user's ability to use the computing device, or important processes (e.g., processes related to important applications like anti-virus applications). The analysis tool may receive information about processes that should or should not be changed from any suitable source, including user input, a central server transmitting information about processes, an operating system vendor, or any other suitable source. The analysis tool may also, in some cases, identify a purpose of a process based on information known about the process or based on observations of the processes behavior. Based on these and/or other criteria, the analysis tool may automatically make changes to the processes, including any of the exemplary types of changes described above.

It should be appreciated that while, in each of the foregoing examples, the usage scenario was described simply as a startup scenario, embodiments are not so limited. Rather, an analysis tool operating according to techniques described herein may be used with any suitable usage scenario.

Techniques operating according to the principles described herein may be implemented in any suitable manner. Included in the discussion above are a series of flow charts showing the steps and acts of various processes that measure and track resource consumption of software processes during usage scenarios and that enable a user to change a configuration of the computing device to change the software processes that are used during usage scenarios. The processing and decision blocks of the flow charts above represent steps and acts that may be included in algorithms that carry out these various processes. Algorithms derived from these processes may be implemented as software integrated with and directing the operation of one or more multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit, or of any particular programming language or type of programming language. Rather, the flow charts illustrate the functional information one of ordinary skill in the art may use to fabricate circuits or to implement computer software algorithms to perform the processing of a particular apparatus carrying out the types of techniques described herein. It should also be appreciated that, unless otherwise indicated herein, the particular sequence of steps and acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, or any other suitable type of software. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations needed to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application. In other implementations, the functional facilities may be adapted to interact with other functional facilities in such a way as form an operating system, including the Windows® operating system, available from the Microsoft® Corporation of Redmond, Wash. In other words, in some implementations, the functional facilities may be implemented alternatively as a portion of or outside of an operating system.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

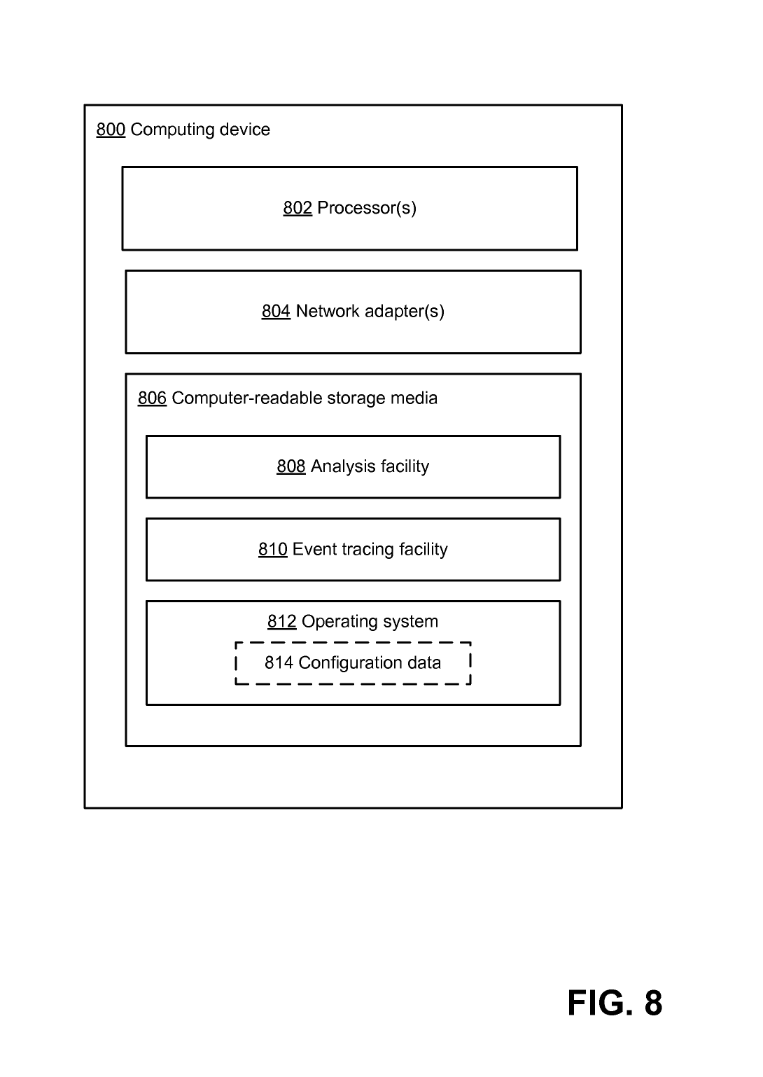

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media 806 of FIG. 8 described below (i.e., as a portion of a computing device 800) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including the exemplary computer system of FIG. 8. Functional facilities that comprise these computer-executable instructions may be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

FIG. 8 illustrates one exemplary implementation of a computing device in the form of a computing device 800 that may be used in a system implementing the techniques described herein, although others are possible. It should be appreciated that FIG. 8 is intended neither to be a depiction of necessary components for a computing device to operate in accordance with the principles described herein, nor a comprehensive depiction.

Computing device 800 may comprise at least one processor 802, a network adapter 804, and computer-readable storage media 806. Computing device 800 may be, for example, a desktop or laptop personal computer, a personal digital assistant (PDA), a smart mobile phone, a server, a wireless access point or other networking element, or any other suitable computing device. Network adapter 804 may be any suitable hardware and/or software to enable the computing device 800 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 806 may be adapted to store data to be processed and/or instructions to be executed by processor 802. Processor 802 enables processing of data and execution of instructions. The data and instructions may be stored on the computer-readable storage media 806 and may, for example, enable communication between components of the computing device 800.

The data and instructions stored on computer-readable storage media 806 may comprise computer-executable instructions implementing techniques which operate according to the principles described herein. In the example of FIG. 8, computer-readable storage media 806 stores computer-executable instructions implementing various facilities and storing various information as described above. Computer-readable storage media 806 may store an analysis facility 808 that may implement any of the exemplary techniques described herein. Computer-readable storage media 806 may additional store an event tracking facility 810 and an operating system 812. The operating system 812 may include configuration data indicating which software processes are to be executed during a usage scenario.

While not illustrated in FIG. 8, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A method comprising:
identifying, based on a configuration of a computing device, at least one software process that the computing device is to execute during operation of the computing device in a usage scenario;
following operation of the computing device in the usage scenario, for each software process of the at least one software process, analyzing information about operations carried out by the computing device to identify an amount of each of at least one resource consumed by the software process throughout the usage scenario; and
presenting via a graphical user interface a listing of the at least one software process and the total amount of each of the at least one resource consumed by each of the at least one software process.

2. The method of claim 1, wherein analyzing the information to identify the total amount of each of the at least one resource consumed by the software process comprises analyzing the information to identify a total amount of processor time used by the software process during the usage scenario.

3. The method of claim 1, wherein analyzing the information to identify the total amount of each of the at least one resource consumed by the software process comprises analyzing the information to identify a total amount of data transferred from a high latency storage device of the computing device by the software process during the usage scenario.

4. The method of claim 3, wherein analyzing the information to identify a total amount of data transferred from a high latency storage device comprises analyzing the information to identify a total amount of data transferred from disk.

5. The method of claim 3, wherein analyzing the information to identify a total amount of data transferred from a high latency storage device comprises:
identifying a first amount of data pre-fetched for the software process and a second amount of data requested by the software process; and
summing the first amount and the second amount to yield the total amount.

6. The method of claim 1, wherein analyzing the information about operations carried out by the computing device in the usage scenario comprises analyzing traces collected during the operation of the computing device in the usage scenario.

7. The method of claim 1, wherein identifying the at least one software process that the computing device is configured to execute during operation of the computing device in the usage scenario comprises identifying at least one startup software process that the computing device is configured to execute during a logon process of the computing device.

8. The method of claim 1, wherein identifying the at least one software process that the computing device is configured to execute during operation of the computing device in the usage scenario comprises identifying, as the at least one software process, first software processes having a high execution priority that the computing device is configured to execute during operation of the computing device in the usage scenario.

9. The method of claim 1, further comprising:
accepting, via the graphical user interface, an instruction from a user to reconfigure the computing device to change software processes that the computing device is configured to execute during operation of the computing device in the usage scenario; and
reconfiguring the computing device in response to the instruction.

10. The method of claim 9, wherein accepting the instruction comprises accepting a first instruction to disable a software process to prevent the software process from executing during the usage scenario, a second instruction to change an order in which the at least one software process is executed during the usage scenario, a third instruction to delay a start of execution of a software process during the usage scenario, or a fourth instruction to change a priority of a software process.

11. At least one computer-readable storage medium encoded with computer-executable instructions that, when executed by a computer, cause the computer to carry out a method comprising:
identifying at least one software process that a computing device is configured to execute during a logon scenario for the computing device;
following operation of the computing device in the logon scenario, for each software process of the at least one software process, analyzing information about operations carried out by the computing device to identify a first total amount of processor time consumed by the software process during the logon scenario and a second total amount of data transferred from disk for the software process during the logon scenario; and
presenting via a graphical user interface a listing of the at least one software process and, for each of the at least one software process, the first total amount and the second total amount.

12. The at least one computer-readable storage medium of claim 9, wherein the method further comprises:
accepting, via the graphical user interface, an instruction from a user to reconfigure the computing device to change software processes that the computing device is configured to execute during operation of the computing device in the logon scenario; and
reconfiguring the computing device in response to the instruction.

13. The at least one computer-readable storage medium of claim 9, wherein analyzing the information to identify a total amount of data transferred from disk comprises:
identifying a first amount of data pre-fetched for the software process and a second amount of data requested by the software process; and
summing the first amount and the second amount to yield the total amount.

14. The at least one computer-readable storage medium of claim 9, wherein the method further comprises identifying, during operation of the computing device in the logon scenario, at least one child process spawned by a software process of the at least one software process,
wherein analyzing the information to identify the first total amount of processor time consumed by the software process comprises summing processor time used by the software process and processor time consumed by the at least one child process.

15. The at least one computer-readable storage medium of claim 9, wherein analyzing the information about operations carried out by the computing device in the usage scenario comprises analyzing traces collected during the operation of the computing device in the usage scenario.

16. An apparatus comprising:
at least one processor adapted to:
identify at least one software process that a computing device is configured to execute during operation of the computing device in a usage scenario;
following operation of the computing device in the usage scenario, for each software process of the at least one software process, analyze information about operations carried out by the computing device to identify a total amount of each of at least one resource consumed by the software process during the usage scenario; and
present via a graphical user interface a listing of the at least one software process and the total amount of each of the at least one resource consumed by each of the at least one software process.

17. The apparatus of claim 16, wherein the at least one processor is adapted to analyze the information to identify the total amount of each of the at least one resource consumed by the software process at least in part by analyzing the information to identify a total amount of processor time used by the software process during the usage scenario.

18. The apparatus of claim 16, wherein the at least one processor is adapted to analyze the information to identify the total amount of each of the at least one resource consumed by the software process at least in part by analyzing the information to identify a total amount of data transferred from a high latency storage device of the computing device by the software process during the usage scenario.

19. The apparatus of claim 16, wherein the at least one processor is further adapted to:
accept, via the graphical user interface, an instruction from a user to reconfigure the computing device to change software processes that the computing device is configured to execute during operation of the computing device in the usage scenario; and
reconfigure the computing device in response to the instruction.

20. The apparatus of claim 16, wherein the at least one processor is adapted to analyze the information about operations carried out by the computing device in the usage scenario at least in part by analyzing traces collected during the operation of the computing device in the usage scenario.
